(19) United States
(12) Patent Application Publication
(10) Pub. No.: US 2002/0082993 A1
(43) Pub. Date: Jun. 27, 2002

(54) Methods and apparatus for executing automated financial transactions

(76) Inventors: Hector Hoyos, Guaynabo, PR (US); Alex Rivera, San Juan, PR (US); Miguel Berrios, Guaynabo, PR (US); Leslie de Jesus, San Juan, PR (US)

Correspondence Address: Patent Law Offices of, Heath W. Hoglund, 391 Juan A. Davila Street, San Juan, PR, 00918, US

(21) Appl. No.: 09/855,832

(22) Filed: May 15, 2001

Related U.S. Application Data
(60) Provisional application No. 60/204,440, filed on May 15, 2000.
(60) Provisional application No. 60/204,170, filed on May 15, 2000.

(51) Int. Cl. G06F 17/60

(52) U.S. Cl. 705/43

(57) ABSTRACT

An automated transaction machine includes a computer coupled with a financial transaction network. The computer is able to receive paper coupons and determine account and vendor information therefrom. The computer is also coupled with a currency acceptor and a debit or credit card acceptor. Payment against the paper coupons may be made through the currency acceptor or card acceptor.

### FIELD OF THE INVENTION

The present invention relates generally to a methods of presenting bills, orders and other services to a customer and to receiving payment for such bills, orders and other services.

### BACKGROUND OF THE INVENTION

In their efforts to look for better ways to manage and support the increasing demand for products and services at financial institutions, the banking industry has turned to the implementation of automated systems that enable faster transaction processing while providing customers with a broader and more accessible variety of services on a “self-service” basis. The flexibility of extended branch hours and multiple transaction processing available at most automated teller machines (“ATM's”) have dramatically altered the way in which customers interact with banks, and have become an additional and almost indispensable convenience to everyday living. Recent improvements to ATM-related machines will allow a customer to pay a bill using a debit or credit card. The bill is scanned and automatically recognized. The customer can then make payment by providing a debit or credit card.

Although the technology supporting these systems has been available, they generally have not been implemented by banks or other financial institutions, due to a number of factors. For one, paper coupons introduce a possibility of error that is generally greater than that associated with electronic transactions. Accordingly, banks and financial institutions have generally favored direct electronic transactions without using a paper coupon.

### SUMMARY OF THE INVENTION

According to one aspect of the invention an automated transaction machine (ATM) having Internet access allows a customer to view outstanding bills by any kind of product or service provider. The ATM also allows a customer to deposit bills from a variety of product or service providers. The bills are automatically recognized by the ATM. The customer may make payment for such bills using credit, debit or smart card or any other form of electronic payment. The customer may also make payment using cash, check or any other standard form of paper payment (e.g., money order, cashiers check, etc.).

According to another aspect of the invention, the ATM is a stand-alone, self-service station that provides a variety of payment and multi-media transactions and applications. The ATM also acts as a physical portal to the Internet. The ATM provides a variety of scanning capabilities and does not require professional operation. An unattended ATM may be operated by a customer. The ATM allows for different types of transactions and/or applications to run under the same platform with a Windows-based environment. As a single unit, it has the ability to process multiple transactions related to the electronic bank's payment application and can also work for other banking applications or other systems. These include information kiosks, and smart card and magnetic stripe reading and writing capabilities. The ATM allows customers to pay their bills, access the Internet, buy tickets, make insurance claims, pay their taxes, communicate with others and shop/surf the Internet. The ATM also allows a customer to purchase pre-paid cellular service or pre-paid long-distance service.

According to another aspect of the invention, the ATM includes a built-in scanner that accepts a customer's coupon, bill, slip or any other paper document. The customer follows through a series of displays and menus that guide him or her through the selection process. The customer may select between a variety of payment and pre-payment options including smart cards, credit cards, debit cards, checks or cash. This process is entirely self-guided by the displays and menus.

According to another aspect of the invention, the ATM reduces or eliminates many processes that would otherwise require subsequent processing by human operators. In other words, the ATM fully automates the above-mentioned transactions.

According to another aspect of the invention, the ATM displays paid commercials or other promotional materials during the processing of a transaction.

According to another aspect of the invention, the ATM provides pre-paid cellular and long distance capabilities. A customer may purchase cellular or long distance using any of the available payment options.

According to another aspect of the invention, an electronic payment transaction is automatically activated by accepting a paper coupon and a payment device at an automated teller machine. A paper coupon that activates an automatic recognition system is received. The automatic recognition system extracts a vendor identification, an account identification and an account balance from the paper coupon. The vendor identification, the account identification and the account balance, and a payment amount are saved as a record in a database. An electronic payment device (e.g. debit card) is received that automatically activates a payment reader. A payment amount is received from a user. A financial transaction network is accessed to issue a debit in the payment amount against an account associated with the electronic payment device. An authorization is received through the financial transaction network authorizing the debit in the payment amount against the account associated with the electronic payment device. The financial transaction network is accessed to issue a credit in the payment amount to an account associated with the vendor identification.

According to further aspects of the invention, an electronic image of the paper coupon is compared with a database of coupon data to determine the associated vendor identification. The record in the database is reconciled against a database maintained by a service provider. The account balance from the paper coupon is presented as a payment amount option to the customer. The financial transaction network is accessed simultaneously to issue the debit and to issue the credit in the payment amount.

According to another aspect of the invention, a paper coupon activates an automatic coupon recognition system. The automatic coupon recognition system extracts a vendor identification, an account identification and an account balance from the paper coupon. Paper bills activate an automatic cash recognition system. The automatic cash recognition system determines an amount of the paper bills and verifies their authenticity. A record of the vendor identification, the account identification, the account balance and the amount of the paper bills are saved. And a financial transaction network issues a credit in an amount less than the amount of the paper bills to an account associated with the vendor identification. The record of the vendor identification, the account information, the account balance and the amount of the paper bills are verified with a remote database associated with a vendor at fixed temporal intervals. An account associated with the account identification is credited in an amount equal to the amount of the paper bills. The difference is credited to an automated teller machine service provider.

These and other aspects of the invention will are described more fully below with reference to the drawings.

### BRIEF DESCRIPTION OF THE DRAWINGS

FIG. 1A shows one preferred ATM that includes a user interface and accepts magnetic stripe cards and paper coupons.

FIG. 1B is a block diagram of the ATM of FIG. 1A including a computer and related interface components.

FIG. 2 is a block diagram of one preferred network configuration suitable for executing transactions between a customer at an ATM, a bank or other financial institution, and various service providers.

FIG. 3A is a flow chart showing one preferred method of executing a bill payment transaction at an ATM.

FIG. 3B is a flow chart showing a second preferred method of executing a bill payment transaction at an ATM.

FIG. 3C is a flow chart showing one preferred method of executing a pre-payment transaction at an ATM.

FIG. 4A is a flow chart showing one preferred method of processing the payment of a bill to a service provider through a financial transaction network.

FIG. 4B is a flow chart showing one preferred method of processing a pre-payment to a service provider through a financial transaction network.

FIG. 5 shows one preferred user interface screen configured to allow a user to select between bank transaction, pre-paid services and bill payment options.

FIG. 6 shows one preferred user interface screen configured to allow a user to select pre-payment to a number of service providers.

### DETAILED DESCRIPTION OF THE PREFERRED EMBODIMENTS

The preferred embodiments described below are part of a group of related inventions. The related inventions are described in U.S. patent application Ser. No ______/______, titled “Coupon Recognition System,” to Hoyos et al., filed on May 15, 2001; and U.S. patent application Ser. No ______/______, titled “Computer Housing,” to Hoyos et al., filed on May 15, 2001. Each of the above-identified applications is incorporated herein by reference in their entirety.

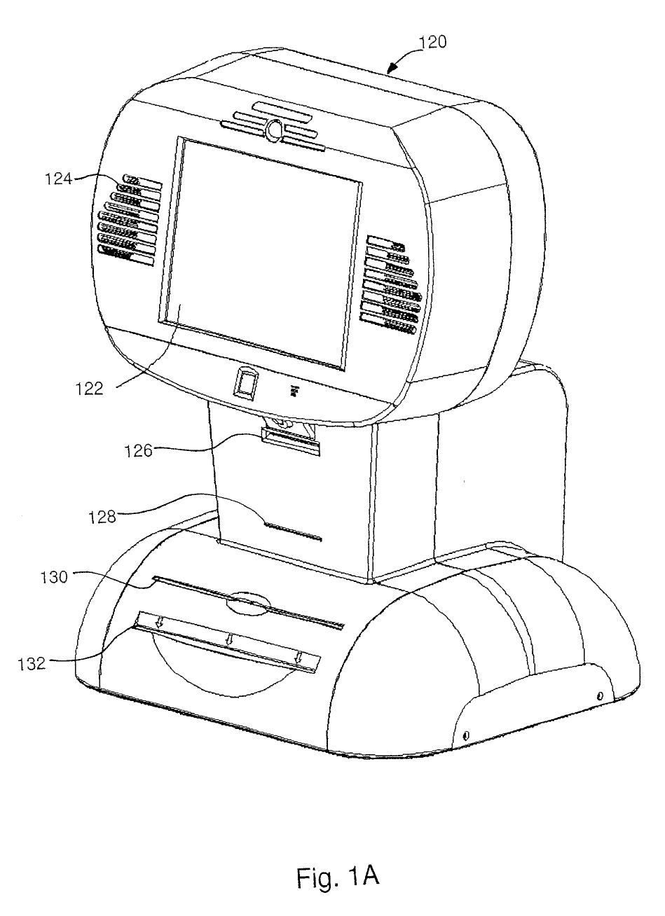

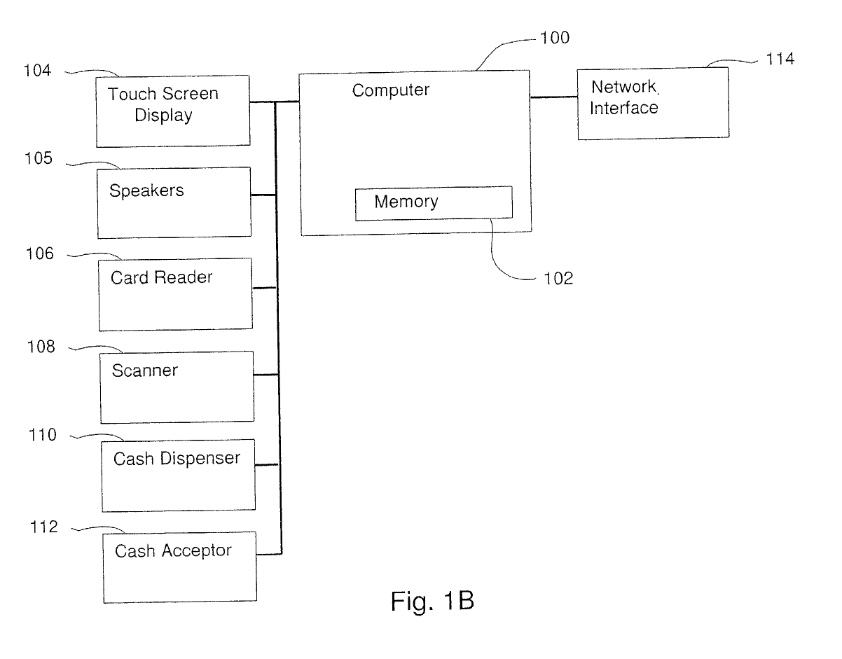

FIG. 1A shows one preferred ATM 120. The enclosure is preferably constructed of a rigid plastic as described in the related patent application titled “Computer Housing.” The ATM 120 includes a touch screen display 122 that is used to present options and receive selections from a customer. ATM also includes speakers 124 that are used to provide marketing or other audio information. In addition, the ATM includes a slot for magnetic stripe cards 126, printing paper receipts 128, for dispensing cash 130 and for accepting paper coupons 132. The ATM is preferably positioned on a stand that includes a cash acceptor (not shown).

Turning to FIG. 1B, a block diagram of one preferred automated transaction machine is described. The automated transaction machine includes a computer 100 having a memory 102. The computer 100 connects with a touch screen display 104. This interface is used to present visual information to a customer, and to receive instructions and data from the customer.

The computer 100 also connects with a card reader 106. The card reader 106 is configured to receive a standard magnetic stripe card. Upon detecting a card, the card reader 106 automatically draws the card across a magnetic sensor to detect card data. This information is provided to computer 100.

The computer 100 also connects with scanner 108. The scanner 108 is a standard color scanner, which may be operated in a black-and-white mode. It is configured to receive a coupon from a customer. Upon receipt, the coupon (or other document) is automatically drawn across an opto-electronic converter. The resulting image data is provided to computer 100 for processing.

According to further aspects of the invention the computer 100 automatically determines the type of the coupon and the associated vendor. The computer 100 then extracts customer account data from the coupon such as customer name, account number and outstanding balance. Details of this system are further described in the related “Coupon Recognition System.”

The computer 100 also connects with a cash dispenser 110. The automated transaction machine may be used to perform the common functions of dispensing cash to a customer. The computer further connects with a cash acceptor 112. This is used to accept paper currency from a customer, especially for the purpose of advancing payment toward a prepaid services account.

The computer 100 also connects to network interface 114. This is used to connect transmit transaction information with a remote information server. These interactions are further described below.

In one preferred embodiment, the ATM includes the following features:

Universal platform, Windows-based environment;

Image acquisition and delivery of data to any central processing station;

Fully integratable to other system platforms;

Scanning capability allows for new product and applications additions;

Ability to communicate with different hosts or central banking systems;

14.4 k to 56 k communications capacity (depending upon the type of modem);

TCP/IP communication;

Includes a general purpose monitoring board that acts as an intelligent monitoring and troubleshooting system;

Provides for local or remote maintenance through a series of easy-to-follow menus;

Smart card and magnetic card reading/writing capabilities;

Complete customer interaction with the system through a touch-screen audible display;

Cash acceptor; and

Physical portal to the Internet.

Moreover, the ATM is implemented on an embedded PC system that includes a number of functional components. These include components that meet at least the following specifications:

Pentium (or equivalent) single board computer with an Ethernet port;

233 MHz Pentium MMX or equivalent or better processor;

Hard disk drive;

Thermal Transfer Receipt Printer;

Motorized Hybrid Card Reader (Magnetic Stripe Reader and Chip Card read/write);

10.4″ TFT LCD Display;

Touch Screen;

14.4 K or faster FAX/Modem;

Document Scanner;

PC-104 PCMCIA adapter;

PC-104 quad serial port module;

Stereo audio output;

+5 VDC and +12 VDC power supply;

+24 VDC power supply;

Temperature and device sensing board;

Power distribution board;

Uninterruptible power supply;

Dock-in station; and

Cash acceptor kit including a bill acceptor, fingerprint scanner and safe box with controller board.

In one preferred mode of operation, the ATM allows a customer to pay bills using any of a plurality of payment options including cash, credit or debit cards or any other standard form of paper or electronic payment. The customer feeds the coupon issued by a service provider into a scanner and the computer performs recognition algorithms to determine who issued the bill, the customer information associated with the bill and the amount of the bill. The customer is then prompted for payment information. Further details of this process are described in the related patent application titled “Coupon Recognition System.”

If a customer elects cash, the customer feeds paper currency into the scanner. The computer performs algorithms to authenticate the currency and to determine its value. If the customer elects check, the customer is reminded that payment information on the check must be typed or written legibly. The customer then feeds the check into the scanner. Again, the computer performs recognition algorithms to determine the amount and account information. The computer may also attempt to determine the payee information. If the customer elects credit or debit card or any other standard form of electronic payment, the payment is processed accordingly.

In addition to bill payment, the customer may also elect to purchase pre-paid cellular or long distance or other services. The ATM connects with a network of merchants or service providers. In one preferred embodiment these include cellular and long-distance service providers. A customer may purchase pre-paid credit from such service providers through the network. Upon receiving payment from the customer, the credit is immediately applied to the customer's account. In one preferred embodiment, this eliminates the need for cards or secret personal identification numbers as are common in the pre-paid telephone services industry.

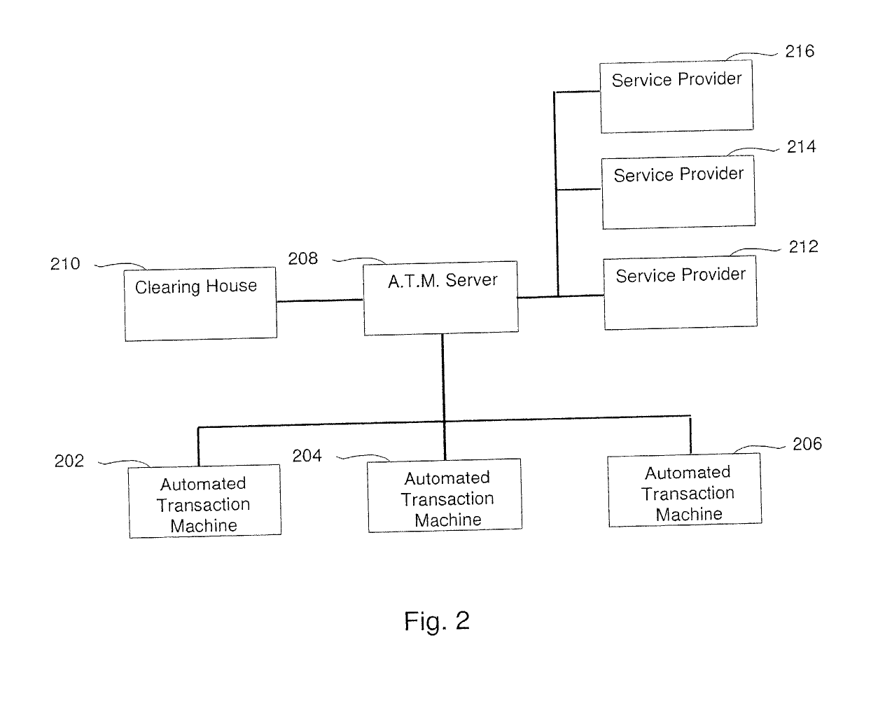

Turning to FIG. 2, one preferred network structure is described. It includes a number of automated teller machines 202, 204 and 206. Only three are shown, however, the system preferably includes a greater number of these devices. They are positioned at various public and retail locations for convenient access for customers. Preferably the machines are placed in high-traffic locations. A customer can use an automated transaction machine to perform a number of different transactions.

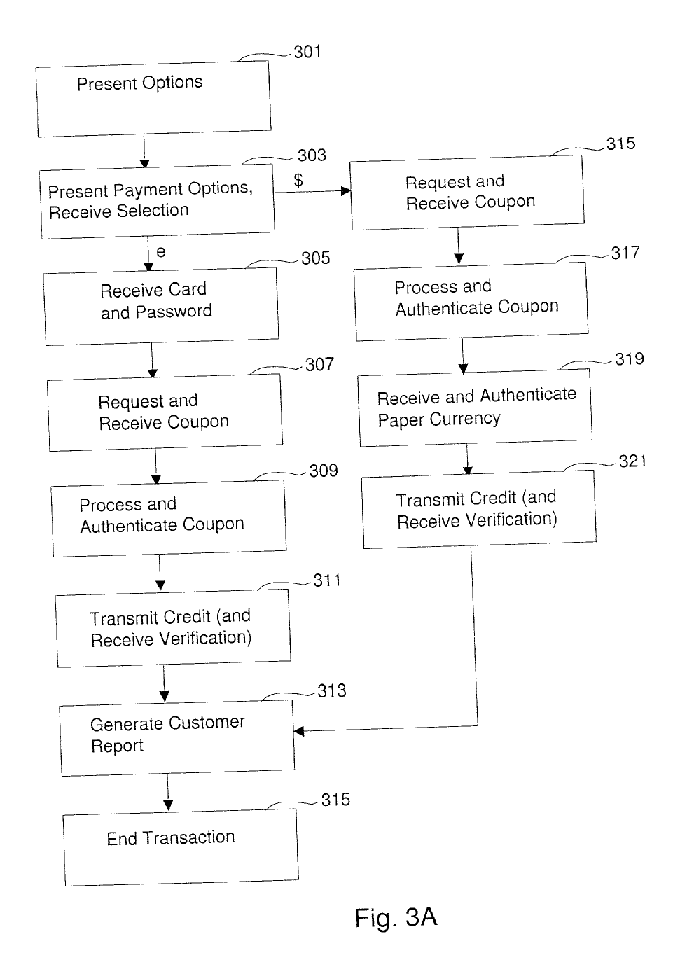

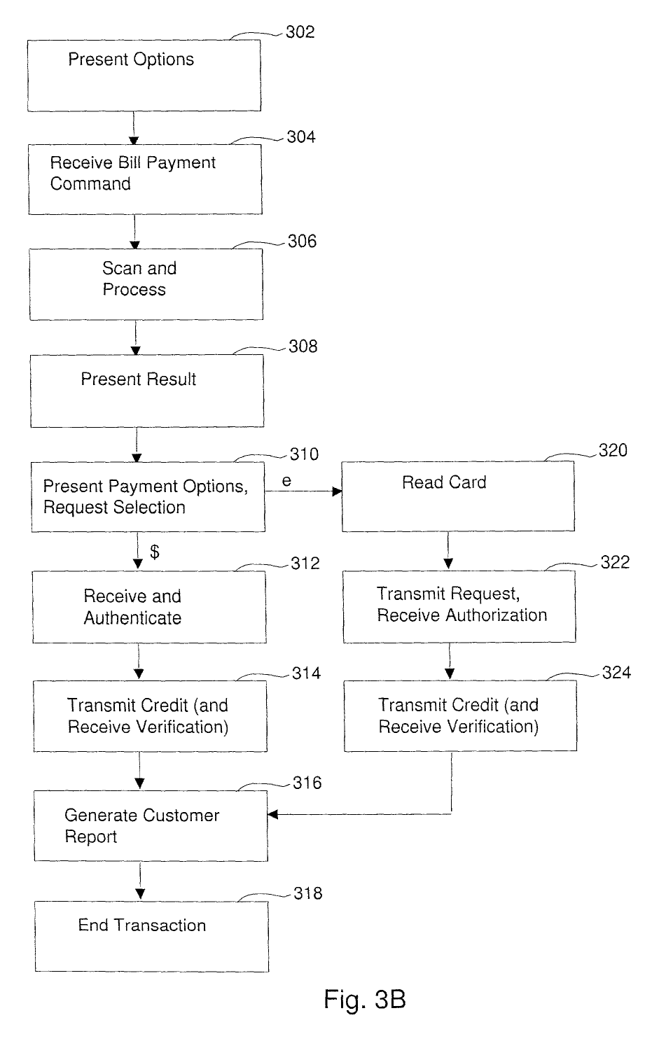

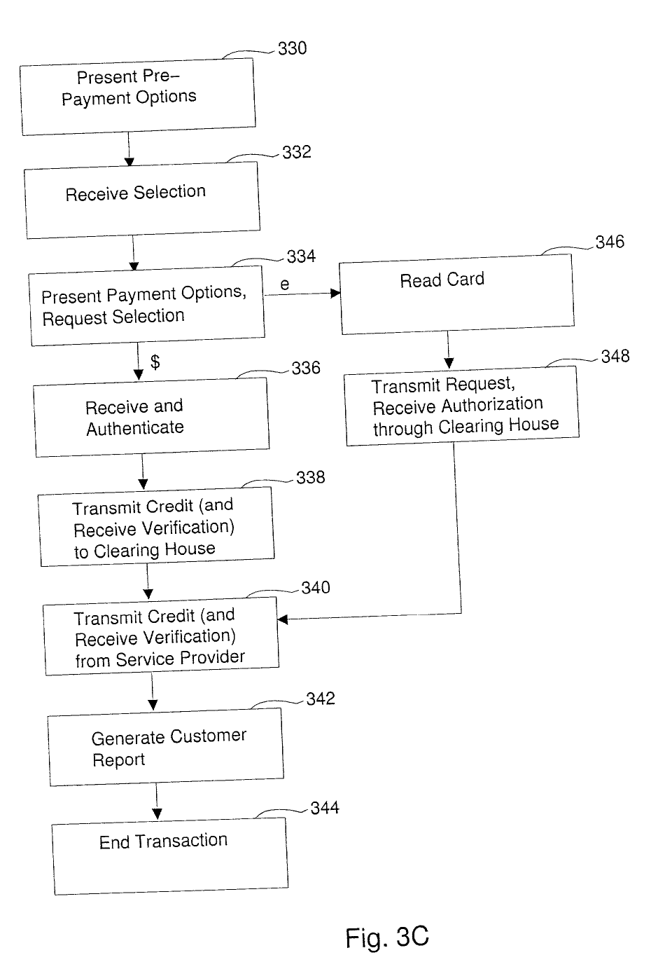

Each of the automated teller machines 202, 204 and 206 connect with a server 208. The server 208 is responsible for monitoring the status of the remote devices. It is also responsible for interfacing with a clearing house 210 or other financial institution and with various service providers 212, 214 and 216. In operation, a customer will access one of the automated teller machines to make a financial transaction such as withdrawing money from an account, paying a bill or prepaying for a service. To execute these transactions, the automated transaction machine performs operations to verify a customer account number, password or other information. Then, a transaction request is transmitted to the server 208. Depending upon the request, the server 208 will contact the clearing house 210 and/or one of the service providers 212, 214 or 216. The details of such transactions are further described below with reference to FIGS. 3A, 3B and 3C.

Turning to FIG. 3A, one preferred method of accepting payment for a paper coupon is described as implemented on the ATM 120. Beginning at step 301, the ATM presents various options to the customer. These include a bank transaction option, a pre-paid services option, and a bill payment option.

Then at step 303, the ATM received, for example, the bill payment command. Here, the ATM then presents payment options including an electronic payment option by debit or credit card, and a cash payment option.

Where the customer selects the electronic payment option, the ATM prompts the user to insert his or her card and to enter an associated password.

Then, at step 307, the ATM prompts the user to present a coupon for payment. At step 309, the coupon is scanned and processed to determine the associated vendor identification, the customer account name and number, and an amount due. This information is presented to the customer for verification. An accept and reject option are also presented that require the customer to confirm the accuracy of the vendor identification, the customer account name and number, and an amount due.

Then, at step 311, the customer is prompted to execute a transfer in the amount due, or another amount that the user may enter. Upon receiving this authorization, the ATM executes a transfer through a financial network. This process completes upon receipt of a transfer verification from a remote server.

Then, at step 313, the ATM prints a transaction record that shows the credit tot he customer's account. The record includes a unique transaction number associated with the log on the ATM. This is used in the event of a network error or subsequent customer complaint.

Returning to step 303, if the ATM instead receives a cash payment request, then at step 315, the ATM prompts the customer to insert a coupon. At step 317, the coupon is scanned and processed to determine the associated vendor identification, the customer account name and number, and an amount due. This information is presented to the customer for verification. An accept and reject option are also presented that require the customer to confirm the accuracy of the vendor identification, the customer account name and number, and an amount due.

Then, at step 319, the ATM prompts the customer to deposit paper currency. This is authenticated.

When the customer finishes depositing currency, the ATM transmits a payment to the vendor at step 321.

Finally, at step 313, the ATM generates a transaction report and the process completes at step 315.

Turning to FIG. 3B, a second preferred method of accepting payment for a paper coupon is described as implemented on the ATM 120. Beginning at step 302, the ATM 120 presents various options to the customer. These include a bank transaction option, a pre-paid services option and a bill payment option.

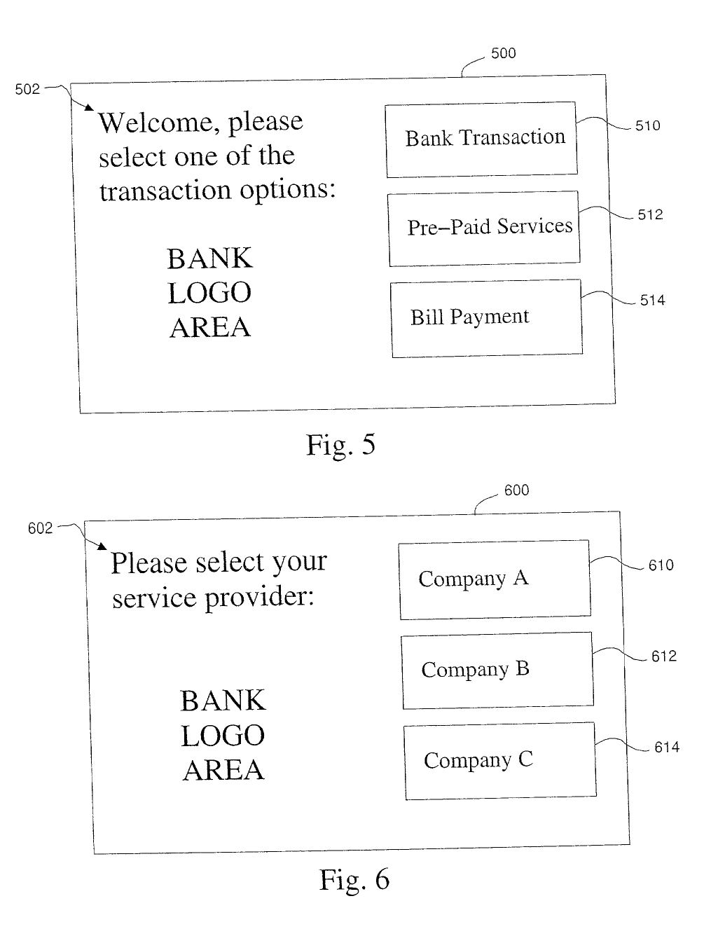

Turning to FIG. 5, one preferred screen interface 500 is shown. It includes a welcome and prompt message 502, as well as an area for a bank or other ATM logo. The screen interface 500 also includes a bank transaction button 510, a pre-paid services button 512 and a bill payment button 514.

The bank transaction option allows a customer to perform transactions such as withdraw money from an account, or transfer funds between accounts. To access this feature, the user must present a debit card (or equivalent) and provide a valid password. The pre-paid services option permits a user to pay in advance for various services that are offered through the network. These include, for example, pre-paid cellular service or pre-paid long distance service. In one preferred embodiment, such prepayment may be made merely by providing a valid telephone number. If that telephone number is associated with one of the service providers on the network, payment is automatically advanced to the associated account. The bill payment option permits a user to make payment against an account where they have received a paper invoice or coupon. To execute this transaction, the customer selects the bill payment option and then present the paper coupon to the scanner.

Returning to FIG. 3B, at step 304, the computer 100 presents a prompt to the customer on the touch screen display 122 requesting that the customer present the coupon through the scanner. In addition, this screen identifies the types of coupons that will be accepted. Of course, in order to process a particular coupon type, the associated vendor or service provider must have enrolled in the system. The list will include all vendors who have made such enrollment.

At step 306, the coupon is received through the scanner and processed to determine the coupon type and associated vendor, and to determine the customer account information such as account number, account name, account balance, etc.

Alternatively, the user may automatically begin the bill payment process simply by inserting the paper coupon in the slot 132 (shown in FIG. 1A). Upon receipt of a paper coupon in the scanner 108, computer 100 (shown in FIG. 1B) automatically begins processing the coupon to determine associated vendor and account information. In other words, receipt of a paper coupon automatically prompts the ATM 120 to begin scanning the coupon and to process the result. In effect, this skips the prompts that are otherwise provided at steps 304.

In any event, at step 308, the ATM presents the result of the processing on the touch screen display. If the coupon is not recognized, the computer will present an error message. Otherwise, the vendor, customer name, account balance and related information are presented on the screen. In one preferred embodiment, verification buttons are provided along with the coupon data. The verification buttons prompt the customer to confirm the accuracy of the recognition process or to reject it if it includes any errors.

Provided the recognition process was successful, the customer is prompted to select a payment option. Preferably, these include at least an electronic payment option such as debit or credit card and a cash payment option.

Where the customer selects a cash payment option, the user is prompted to provide currency through the cash acceptor. At step 312, the currency is received and authenticated.

When the customer finishes depositing payment, at step 314 the ATM generates a log record of the transaction and transmits a credit to the associated service provider. Preferably, this credit is made through an electronic financial network.

Then, at step 316, the ATM prints a transaction record that shows the credit to the customer's account. The record includes a unique transaction number associated with the log on the ATM. This is used in the event of a network error or subsequent customer complaint.

Returning to block 310, in the event that the customer request electronic payment, then the customer provides their credit or debit card at step 320. The ATM reads the card and request the customer's unique password. The customer is further prompted as to whether they would like to make payment in the amount due or in another amount. If they select another amount, they are further prompted to enter that amount.

After receiving this information, the ATM logs the information and transmits an authorization request against the customer's account. If authorized, the funds are automatically transferred to the associated vendor at step 324. The ATM also receives a verification that the transaction was completed successfully.

Upon receiving that verification, at step 316, the ATM generates a customer report showing the credit to their account.

Then, at step 318, the transaction is completed and the customer may end the session or select another transaction option.

The cost of providing this payment service by the ATM network is paid by providing a commission from the respective service provider to the network provider. For example, for each payment made through an ATM to the service provider, the network provider receives either a fixed fee or a fraction of the transaction amount.

Turning to FIG. 3C, one preferred method of accepting pre-payment for services is described as implemented on the ATM 120. At step 330, the computer 100 presents a number of pre-payment options. These identify the serve providers from which this option applies. Of course, in order to participate, a service provider must have enrolled in the system.

Turning to FIG. 6, one preferred interface screen 600 is described. It includes an instruction message 602 directing the customer to select a service provider. It also includes a buttons 610, 612 and 614, each of which is associated with one vendor.

At step 332, the ATM receives a selection for one of the service providers. Pre-payment amounts are presented along with service rates. The customer also selects a pre-payment amount.

At step 334, the customer is prompted to select a payment option. Preferably, these include at least an electronic payment option such as debit or credit card and a cash payment option.

Where the customer selects a cash payment option, the user is prompted to provide currency through the cash acceptor. At step 336, the currency is received and authenticated.

When the customer finishes depositing payment, at step 338 the ATM generates a log record of the transaction and transmits a credit to the associated service provider through an electronic transfer made through a clearing house.

Next, at step 340, the ATM transmits a credit verification to the service provider. This transmission is made to ensure that the service provider immediately makes activates the credit for the customer's account. The ATM awaits a confirmation from the associated service provider that the user's account has been activated.

Next, at step 342, the ATM generates a customer report. This report is generated on a printed slip that identifies the service provider, the customer account and the credit amount.

The process then completes at step 344 and the customer is prompted to make any additional transactions.

Returning to block 334, if the customer elects to make an electronic transfer, then at step 346, the customer provides their credit or debit card. The card is read and the customer further provides password information.

After receiving this information, the ATM logs the information and transmits an authorization request against the customer's account. If authorized, the funds are automatically transferred to the associated vendor at step 348. The ATM also receives a verification that the transaction was completed successfully.

Upon receiving that verification, the ATM transmits a credit to the respective service provider as explained with reference to step 340 et seq.

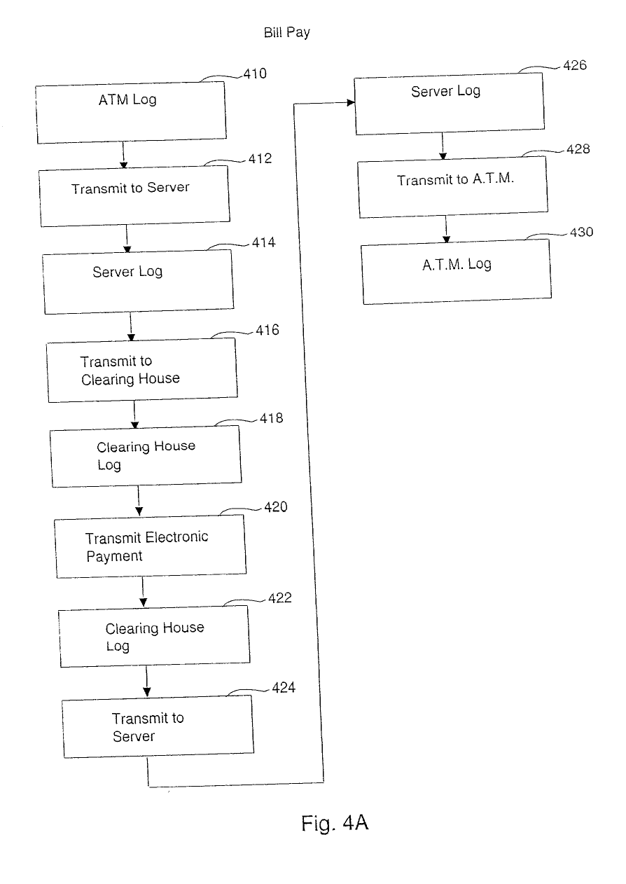

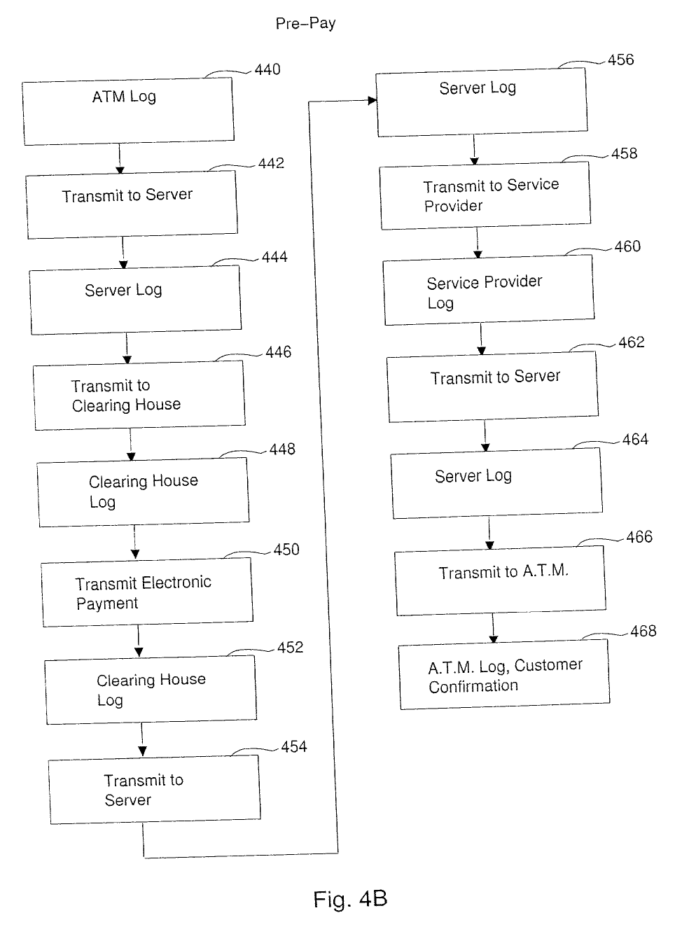

Turning to FIG. 4A, the process of executing a bill pay transaction over the network shown in FIG. 2 is further described. Beginning at step 410, upon identifying a coupon and receiving a credit or debit card, the ATM logs the transaction by saving a record in a database.

Then, at step 412, the ATM transmits a debit request to the ATM server. The debit request includes the source (ATM identifier), the customer account information and the vendor account information. At step 414, the ATM server also logs the transaction request. Then, at step 416, the ATM server transmits an electronic transaction request to a clearing house. Depending upon the particular implementation, the clearing house may be a bank or any other financial institution having access to an electronic transfer network.

At step 418, the clearing house logs the transaction. Then, at step 420, the clearing house directs an electronic transfer from the customer's account to the vendor's account. Again, at step 422, the clearing house logs this transaction. Then, at step 424, the clearing house transmits a verification report to the ATM server indicating completion of the transaction.

At step 426, the ATM server logs the completion of the transfer. This log includes the transaction record. The ATM server then transmits a verification to the ATM at step 428. Here, the completion of the transaction is again logged along with the transfer record at step 430. The ATM then prints or presents the record to the customer.

At the end of a day (or other determined period) the accounts of the service provider are reconciled by comparing the log records of the ATM server against the actual credits received in the service provider's account. Any discrepancies can be tracked by following the detailed transfer records stored in the ATM server logs against the service provider's logs.

Turning to FIG. 4B, a related process used in a pre-payment transaction is described. Here, the customer has elected to purchase a pre-paid service from a particular vendor. Unlike the bill payment transaction, the service provider's records should be updated immediately upon making the transaction so that the user has immediate access to the pre-paid service.

The process initially follows the same flow as described with reference to FIG. 4A. In particular, steps 440-456 of FIG. 4B, follow steps 410-426 of FIG. 4A.

Then, at step 458, after logging a payment verification, the ATM transmits a record to the associated service provider. At step 460, the service provider logs the transaction record and activates or credits the associated account. Then, at step 462, the service provider transmits a confirmation to the ATM server. Upon receipt, at step 464, the ATM server logs the confirmation. Then, at step 466, the ATM server transmits the confirmation to the ATM. In turn, at step 468, the ATM logs the transaction and provides a confirmation report to the customer. The confirmation report includes a transaction record associated with the service provider so that the customer may contact them directly if the service is not activated properly.

Although the invention has been described with reference to specific preferred embodiments, those skilled in the art will appreciate that many variations and modifications may be made without departing from the scope of the invention. The following claims are intended to cover the disclosed embodiments as well as all such variations and modifications.

We claim:

1. A method of automatically activating an electronic payment transaction by accepting a paper coupon and a payment device at an automated teller machine comprising the steps of:
receiving a paper coupon that activates an automatic recognition system, wherein the automatic recognition system extracts a vendor identification, an account identification and an account balance from the paper coupon;
saving the vendor identification, the account identification and the account balance as a record in a database;
receiving an electronic payment device that automatically activates a payment reader;
receiving a payment amount from a user;
accessing a financial transaction network to issue a debit in the payment amount against an account associated with the electronic payment device;
receiving an authorization through the financial transaction network authorizing the debit in the payment amount against the account associated with the electronic payment device; and
accessing the financial transaction network to issue a credit in the payment amount to an account associated with the vendor identification.

2. The method of claim 1, wherein the step of receiving a paper coupon further comprises generating an electronic image of the paper coupon and comparing the electronic image with a database of coupon data to determine the associated vendor identification.

3. The method of claim 1, wherein the step of saving the vendor identification, the account identification and the account balance as the record in the database further comprises saving the payment amount from the user;

4. The method of claim 3, further comprising the step of reconciling the record in the database against a database maintained by a service provider.

5. The method of claim 1, wherein the step of receiving an electronic payment device comprises receiving a debit card.

6. The method of claim 1, wherein in the step of receiving the payment amount from the user, the account balance from the paper coupon is presented as a payment amount option.

7. The method of claim 1, wherein the step of accessing the financial transaction network to issue the debit and the step of accessing the financial transaction network to issue the credit in the payment amount are performed simultaneously.

8. A method of automatically activating an electronic payment transaction by accepting a paper coupon for payment and a paper currency as payment at an automated teller machine comprising the steps of:
receiving a paper coupon that activates an automatic coupon recognition system, wherein the automatic coupon recognition system extracts a vendor identification, an account identification and an account balance from the paper coupon;
receiving one or more paper bills that activates an automatic cash recognition system, wherein the automatic cash recognition system determines an amount of the paper bills and verifies their authenticity;
saving a record of the vendor identification, the account identification, the account balance and the amount of the paper bills; and
accessing a financial transaction network to issue a credit in an amount less than the amount of the paper bills to an account associated with the vendor identification.

9. The method of claim 8, wherein the step of receiving the paper coupon further comprises generating an electronic representation of the paper coupon and comparing the electronic representation with a database of coupon data to determine the vendor identification.

10. The method of claim 8, further comprising the step of verifying the record of the vendor identification, the account information, the account balance and the amount of the paper bills with a remote database associated with a vendor at fixed temporal intervals.

11. The method of claim 8, further comprising the step of crediting an account associated with the account identification in an amount equal to the amount of the paper bills.

12. The method of claim 11, further comprising the step of crediting an automated teller machine service provider in an amount that does not exceed the difference between the credit to the account associated with the account identification and the credit to the account associated with the vendor identification.

13. A computerized transaction machine configured to receive paper coupons from a customer, accept payment from the customer and issue a credit to a vendor, comprising:
a scanner configured to receive a paper coupon from a customer and to generate an electronic representation of the same;
a magnetic card reader configured to receive a debit or credit card from the customer;
a touch-screen display configured to present payment options and transaction information to a customer and to receive instructions from the customer;
a network interface configured to communicate with a financial transaction network; and
a computer having a memory and operationally coupled with the display, the scanner, the magnetic card reader and the network interface wherein the computer is configured to:
receive the electronic representation of the paper coupon from the scanner;
receive an account identification from the magnetic card reader;
direct the display to present a payment option in an amount determined from the electronic representation of the paper coupon;
receive a payment amount through the touch-screen display;
transmit a transfer request through the network interface; and
save transaction records in the memory, wherein the transaction records include an amount, a vendor and customer identification, and payment source identification.

14. The computerized transaction machine of claim 13, further comprising a printer operationally coupled with the computer and configured to provide transaction records to the customer.

15. The computerized transaction machine of claim 13, further comprising a cash acceptor configured to receive paper currency from the customer as payment against the paper coupon.
